(19) United States
(12) Patent Application Publication
(10) Pub. No.: US 2004/0123130 A1
(43) Pub. Date: Jun. 24, 2004

(54) Method and apparatus for distributing and activating security parameters

(75) Inventors: Akshay Mathur, Maple Shade, NJ (US); Pankaj Dani, Maple Shade, NJ (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: Inrange Technologies Corporation

(21) Appl. No.: 10/324,015

(22) Filed: Dec. 20, 2002

(51) Int. Cl. H04L 9/00

(52) U.S. Cl. 713/200

(57) ABSTRACT

An apparatus and method for distributing and activating a new security parameter in a computer network in a non-disruptive manner includes transmitting a new security parameter to the an element in the network, instructing the element to place the new security element in a pending database of the element and activating the new security parameter. The present invention also determines possible conflicts in the computer network.

### FIELD OF THE INVENTION

The present invention relates generally to computer network security. More particularly, the present invention relates to method and apparatus for activating security parameters within a network.

### BACKGROUND OF THE INVENTION

With the birth of computer networks, data communications has become revolutionized. The networks have allowed computers from many different locations to exchange information. It has done so by providing protocols and addressing schemes which enable various computers to be able to communicate to one another regardless of the computer system's physical hardware, the kind of physical network it is connected to, or the kinds of physical networks that are used to send the information from the one computer system to the other computer system. In order for two computer systems to exchange information in a network such as the Internet, each computer system has an Internet address and the software necessary for the protocols to route information between the two machines by way of some combination of the many physical networks that may be used to carry messages constructed according to the protocols.

However, this modern convenience, which has allowed us to exchange information, has some draw backs. One draw back is the security of information on computers that are attached to the networks. For example, a large corporation can have all of their computers communicate within an internal and external network. The problem occurs in the ability of others to be able to go into these internal networks through the external network and get access to sensitive information.

The Internet has made it difficult for companies to protect information from nefarious individuals with sufficient computer skills to gain access to company information. If information may be accessed at all via the Internet, it is potentially accessible to anyone with access to the Internet. Once there is Internet access to information, blocking these individuals becomes a difficult technical problem.

One of the components of the computer networks is a switch. A switch in a network device selects a path or circuit for sending a unit of data to its next destination. A switch may also include the function of the router, a device or program that can determine the route and specifically what adjacent network point the data should be sent to. In general, a switch is a simpler and faster mechanism than a router, which requires knowledge about the network and how to determine the route.

Network elements such as switches are added, deleted and modified almost on a weekly basis. With such alterations to the computer network, the overall network security needs to be monitored to ensure that any modification to the network does not compromise the security.

Prior art solutions have been to physically enable the security at each network element individually. The problem with such an approach is that some elements are physically in different locations with different individuals handling the security. A further problem with this approach is the network elements must be removed or disabled from the network to enable security. This results in the loss of valuable processing time.

Other problems with the prior art methods are those elements that are removed from the network must be removed from the security listing. Again this requires the network technicians to move this element from the listing. If such action is not taken, then a hole is left open which allows outsiders access into the computer network.

Furthermore, in permitting network elements to be secured individually, there is a possibility for non-uniformity of security parameters. As with the previous solutions, these leaves the system vulnerable to penetrations from unauthorized users.

Other solutions are firewalls. The firewalls perform network address translation and filtering on data packets at the network level. These networks also translate the server-based addresses, addresses made available by the internal network as its domain name system for use by incoming data packets, into addresses internal to an organization's internal network. Only the data packets that have passed inspection by the packet filter's access control list (ACL) receive the internal addresses. For instance, the ACL may permit file transfer protocol (FTP) traffic to pass only if it is addressed to a certain part of the trusted environment.

Another prior art solution is context filtering. This technique involves accumulating a database of data related to incoming packets. Data is only authorized for these packets is consistent with session criteria for that data.

All of these solutions are deficient in that they don't allow network mangers or administrators the capacity to efficiently set uniform security across a network.

Accordingly, it is desirable to provide a system in which a security parameter can be set and activated uniformly across the computer network. If it also desirable to provide a system in which the security parameters can be set or implemented in a non-disruptive manner.

### SUMMARY OF THE INVENTION

One aspect of the present invention to provide a mechanism from a central location to uniformly permit security parameters to be distributed and activated in a non-disruptive manner.

In another aspect of the present invention a mechanism is provided to determine whether any conflicts exists either in the network topology or the security parameter once it is selected by the user.

The above and other features and advantages are achieved through the use of a novel apparatus and method wherein a security parameter is set, transmitted and activated by the elements with a computer network as herein disclosed. In accordance with one embodiment of the present invention, A method for non-disruptively distributing and activating security parameters in computer network, includes setting a new security parameter for an element in a network, determining the network topology and whether any conflict exists with the new security parameter, sending the new security parameter to an element in the computer network, placing the new security parameter in an active database of the element and activating the new security parameter. The method can also include transmitting the security parameter to a network endpoint element in response to a switch receiving the new security parameter. When the new security parameter is transmitted to the network element, it is stored in a pending database of the element.

To activate the new security parameter, a commit command is transmitted to the network elements. This instructs the network elements to transfer the new security parameter from the pending database to the active database. Once this is completed, an activate command is transmitted and the new security parameter is initialized.

Activating includes the step of the network element exchanging security capability parameters (ESCP) among elements in the computer network. If the exchange is successful, the network elements exchange a network element list. If the network element list or the ESCP is not successful, then the link is shut down.

If during the determination of the network topology a new inter switch link is detected a security procedure is completed to ensure proper security. One the link is identified, the new network element completes the step of exchanging security capability parameters (ESCP) among elements in the computer network. If the exchange is successful, the network elements exchange a network element list. If the network element list or the ESCP is not successful, then the link is shut down.

In accordance with another embodiment of the present invention, an apparatus for non-disruptively distributing and activating security parameters in computer network includes means for sending a new security parameter to an element in the computer network, means for placing the new security parameter in a means for storing located in the element and means for activating the new security parameter. The apparatus can further include means for transmitting the security parameter to a network endpoint element in response to a switch receiving the new security parameter.

In accordance with an alternate embodiment of the present invention, an apparatus for distributing and activating a security parameter in computer network includes a security parameter generator, which comprises generating a security capability parameter and network element list, a transmitter linked to the security parameter generator, a instructor linked to the transmitter, wherein the instructor generates and instruction concerning the new security parameter and an activator linked to the transmitter, wherein the activator transmits a command to initialize the new security parameter. One of the commands is to commit, which instructs the network element to transfer the new security parameter from the pending database to the active database.

This alternate embodiment can also include a determinator linked to the transmitter that analyzes and determines the computer network topology and the current security parameter for the network element.

In another alternate embodiment, a computer readable medium containing executable code includes sending a new security parameter to an element in a computer network, placing the new security parameter in an active database of the element and activating the new security parameter. This alternate embodiment can further include transmitting the security parameter to a network endpoint element in response to the switch receiving the new security parameter. The new security parameter can be stored in a pending database of the element. A switch then receives an activate command and distributes the activate command to the network endpoint element. The computer network can an Ethernet or fiber channel network.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of the present invention.

FIG. 2 is an illustration of the preferred embodiment of the present invention.

FIG. 3 is an illustration of the present invention in a fiber channel network.

### DETAILED DESCRIPTION OF PREFERRED EMBODIMENTS OF THE INVENTION

A preferred embodiment of the present invention provides an apparatus and method that permits a user to set a security parameter for a network elements and have the security parameter activated in a non-disruptive manner.

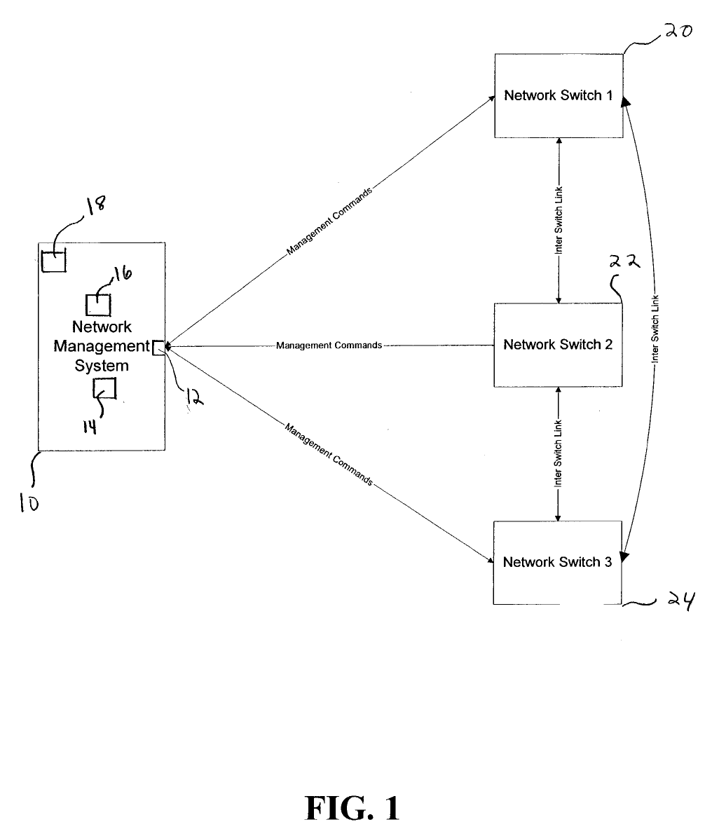

A preferred embodiment of the present inventive apparatus and method is illustrated in FIG. 1. This figure is a block diagram that illustrates the preferred embodiment. The preferred embodiment is comprised of a network management system (NMS) 10. The NMS 10 includes a transmitter 12, an instructor 14, a security parameter generator 16, and an activator 18. The NMS 10 serves as the central station to where security of the computer network is maintained and monitored.

The NMS 10, in the preferred embodiment, is linked to network elements. The network elements, in the preferred embodiment, are network switch. However, the network elements could be routers, access points, Ethernet cards, hubs, connectors, modem, switches or servers.

The NMS 10 serves as the basis point for a user to control and monitor the security of the computer network. At this point, a user alters or changes the security parameter to a desired level. The security parameter is then transmitted or sent to the network elements such as the switches 20, 22, 24. The transmitted security parameter is essentially a management command to the switches 20, 22, 24. The management command instructs the switches 20, 22, 24 to initiate a certain level of security.

The switches 20, 22, 24 can be linked together in the computer network. The link from one switch 20 to another switch 22 is called a Inter Switch Link. The switches 20, 22, 24 need not be placed in a side by side configuration for the switches 20, 22, 24 to be connected or linked. The switches 20, 24 can be connected via an Inter Switch Link even though their physical configuration is not next to each other.

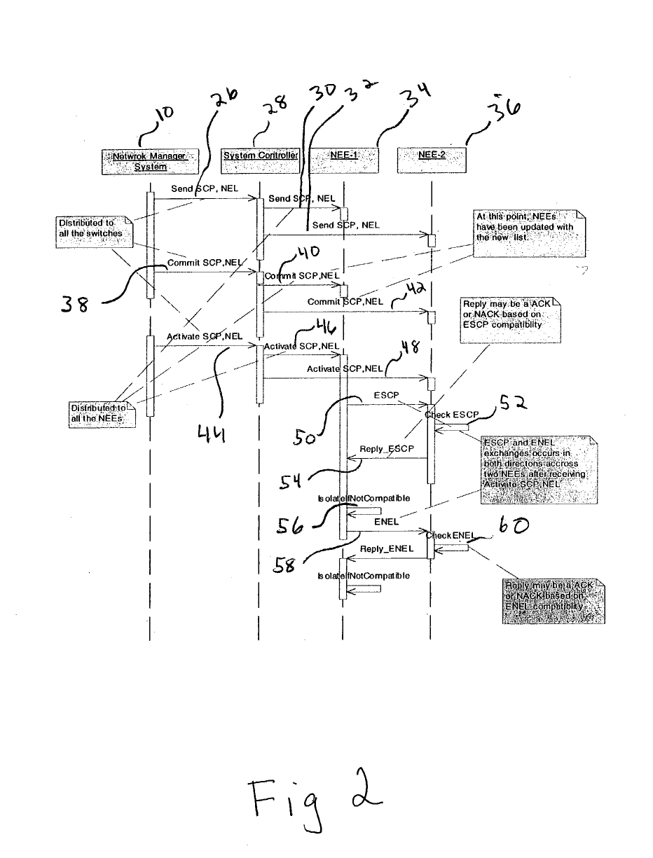

FIG. 2 is an illustration of the preferred embodiment of the present invention. The network manager or user sets the security parameters at the NMS 10. The security parameter includes the security capability parameters (SCP) and the network element list (NEL). At this point, the NMS queries all the switches in the computer network to obtain the current or latest security setting or capabilities and the topology of the network.

From this point, the NMS 10 computes any potential security parameter or topology conflicts. Such conflicts can cause a network element such as the switch to become isolated from the network. In the preferred embodiment, the user is informed and requested to acknowledge the conflict.

The NMS 10 then sends 26 the new security parameters one by one to the switches 20, 22, 24. A switch controller 28 receives and stores the new security parameter. In the preferred embodiment, the new security parameter is stored or preserved in a pending database. The switch controller 28 then distributes 30,32 it to all the network endpoint elements (NEE) 34, 36, which preserve or store it in their pending database.

The NMS 10 then sends a commit instruction 38 to all the switches 20, 22, 24. The commit instruction 38 instructs the switch controller 28 to transfer or move the security parameter from the pending database to the active database.

The switch controller 28 in the switches 20, 22, 24 distributes the commit instruction 40, 42 to the NEEs 34, 36. Similar to the switches 20, 22, 24, the NEEs 34, 36 place the security parameter from the pending database to the active database. At this point in time, the whole network, e.g. all the distributed security databases and NEEs 34, 36, have a uniform set of security parameters.

Following the commit instructions 40, 42, the NMS 10 distributes an activate command to all the switches. The switch controller 28 in the switches 20, 22, 24 then distributes the activate command 46, 48 to the NEE 34, 36.

At this point in the process, the security parameters proceed to an initialization process before they become active within the system. This initialization includes the active network elements exchanging the SCP using exchange security capability parameters (ESCP) 50. A check 52 is made to ensure that the active network elements have, uniform security parameters. A reply 54 with the result of this check 52 is returned. A mismatch or non-compatibility of the security parameters in the SCP among the any two network elements causes the Inter Switch Link to close, shutdown or isolated 56.

If the ESCP 50 is successful, then all the active networks elements exchange 58 the NEL. A NEL check 60 is performed to determine the capability of uniformity of the NEL among the active network elements. Similar to the ESCP, if the check determines that the NELs are not uniform or compatible, then the Inter Link is isolated or shut down.

The present invention provides a mechanism for distributing and activating security attributes to the switches in the computer network before the new security is activated. The initialization process, in which the network elements compare SEL and NEL, provides a means or process by which activation of the new security is achieved.

The new security parameter or attribute is activated non-disruptively, unless there is a mismatch during the exchange of the SEL and NEL. This is achieved by breaking the process into two phases: distribution and activation. As a result, there is no time window in which two switches can have different security parameters.

The present invention is capable of being implemented into a variety of computer networks. The computer networks can be Ethernet, WAN, LAN and Ficon.

The present invention also has the ability to apply and activate a security parameter through in-band messaging. In-band messaging is a means whereby the new security parameter and activation messages or instructions can flow from the NMS 10 to a first switch and then propagated to another switch through an Inter Link Switch. This is accomplished by transmitting a special message to the switch controller of the other switch. This later switch and its controller then distributes it to its NEE. As a result, all the network switches need not be directly linked to the NMS 10 through an external communication path.

In-band messaging in the present invention relies on switches that were originally attached to the computer network or were not isolated due to a mismatch in security parameter.

In an alternate embodiment of the present invention, a connected remote switch is enabled to be connected and secured after a new inter switch link has been discovered during the analyzing phase of the computer network. The immediate concern, upon this discovery, is the security threat that the switch presents. To ensure the a proper and uniform level of security, a security exchange is conducted. The security exchange occurs if the security database is active in the newly discovered switch. Essentially, the new switch is processed through an authorized or authenticate procedure.

After the inter switch link is discovered, the switch is analyzed for compatibility. If the switch is not compatibility, the inter link switch is isolated or shut down. If the switch is compatible, the newly discovered switch is transitioned into the security validation phase. During this phase, the newly connected inter link switch link exchanges SCP using ESCP. If there is a mismatch in SCP, then the inter link switch is isolated or shut down.

If the SCP is successful, then all the network elements exchange the NEL using ENEL. If during this exchange there is non-uniformity or a mismatch of the NEL, then the inter link is shutdown. Additionally, all the switches analyze their surrounding switches to ensure that they are a part of the NEL. If during this process it is determined that they are not, then the inter switch link is isolated or shut down.

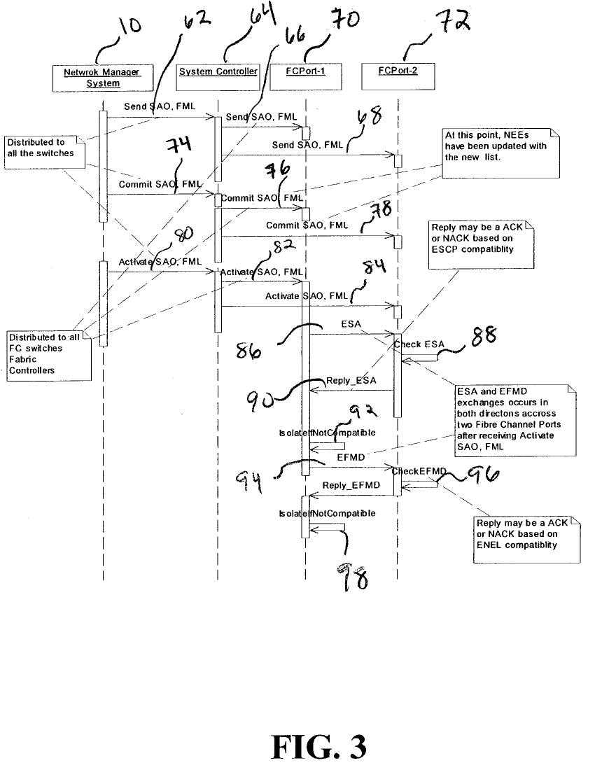

FIG. 3 is an illustration of the present invention in a fiber channel (FC) network. A security administrator creates or modifies the security attributes object (SAO) and the fabric membership list (FML) from the NMS 10. The NMS 10 then distributes 62 the SAO and FML to the switches in the FC network.

The security parameters includes the SCP, SAO in fiber channel protocol, and the NEL, FML in fiber channel protocol. The NMS queries switches in the FC network to collect the current or latest security capabilities and in addition to the topology of the fabric. Upon collecting the capabilities and topology, the NMS computes any potential SAO or FML conflicts. The user is notified of any potential conflicts.

The NMS 10 then sends 62 the security parameters to the switches in the computer network. The switch controller 64 receives and stores the security parameter for an unspecified length of time. The NMS 10 can transmit the security parameters one at time or simultaneously.

After the switch controller 64 receives the security parameters, it sends or transmits 66 the security parameters to the NEE, which in the FC network can be such items as fiber channel ports 68, 70, which store the security parameter in their pending database.

The NMS 10 then sends a message or instruction to the fiber channel system controller 64 to commit 74 the security parameter. This message instructs the system controller to move the security parameter from the pending database to the active database.

Upon receiving the message, the system controller 64 transmits the commit instruction 76, 78 to the fiber channel ports 70, 72. As with the fiber channel controller 64, the fiber channel ports 70, 72 transfer the security parameters from their pending database to their active database. At this point in time, all the NEE and switches in the FC network have a uniform set of security parameters.

Following the commit instructions 70, 72, the NMS transmits an activate command 80 to all the switches. The switch controller 64 then distributes the activate command 82, 84 to all the NEEs. The activate command 82, 84 also instructs the NEEs to move the security parameter from the pending database to the active database.

At this point in the process, the security parameters proceed to an initialization process before they become active within the system. This initialization includes the active network elements exchanging the SCP using exchange security attributes (ESA) 86. A check 58 made to ensure that the active network elements have uniform security parameters. A reply 90 with the result of this check 88 is returned. A mismatch or non-compatibility of the security parameters in the SCP among the any two network elements causes the Inter Switch Link to close, shutdown or isolated 92.

If the ESCP 86 is successful, then all the active networks elements exchange 94 the FML using exchange fabric membership data (EFMD). A FML check 96 is performed to determine the capability of uniformity of the FML among the active network elements. Similar to the ESCP, if the check determines that the NEL are not uniform or compatible, then the Inter Link is isolated or shut down 98.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for non-disruptively distributing and activating security parameters in computer network, comprising the steps of:
sending a new security parameter to an element in the computer network;
placing the new security parameter in an active database of the element; and
activating the new security parameter.

2. The method as in claim 1, wherein the element is a switch.

3. The method as in claim 2, further comprising transmitting the security parameter to a network endpoint element in response to the switch receiving the new security parameter.

4. The method as in claim 1, wherein the new security parameter is stored in a pending database of the element.

5. The method as in claim 3, wherein the new security parameter is stored in a pending database of the network endpoint element.

6. The method as in claim 3, wherein the switch, in response to receiving an activate command, distributes the activate command to the network endpoint element.

7. The method as in claim 1, wherein the step of activating the new security command comprises exchanging security capability parameters (ESCP) among elements in the computer network.

8. The method as in claim 7, wherein if the ESCP is successful, then the elements exchange a network element list.

9. The method as in claim 7, wherein if the ESCP is not successful, then a link is shut down.

10. The method as in claim 9, wherein the link is a Inter Switch Link.

11. The method as in claim 8, wherein if the network element list is not successful, then a link will shut down.

12. The method as in claim 1, further comprising setting the new security parameter.

13. The method as in claim 12, further comprising determining a current security parameter of the element in the computer network.

14. The method as in claim 13, further comprising identifying any potential conflict.

15. The method as in claim 13, further comprising identifying a new inter switch link in the computer network.

16. The method as in claim 15, further comprising exchanging security capability parameters (ESCP) among elements in the computer network.

17. The method as in claim 16, wherein if the ESCP is successful, then the elements exchange a network element list.

18. The method as in claim 7, wherein if the ESCP is not successful, then the new inter switch link is shut down.

19. An apparatus for non-disruptively distributing and activating security parameters in computer network, comprising:
means for sending a new security parameter to an element in the computer network;
means for placing the new security parameter in a means for storing located in the element; and
means for activating the new security parameter.

20. The apparatus as in claim 19, further comprising means for transmitting the security parameter to a network endpoint element in response to a switch receiving the new security parameter.

21. The apparatus as in claim 19, wherein the means for storing is a pending database.

22. An apparatus for distributing and activating a security parameter in computer network, comprising:
a security parameter generator, which comprises generating a security capability parameter and network element list;
a transmitter linked to the security parameter generator;
a instructor linked to the transmitter, wherein the instructor generates and instruction concerning the new security parameter; and
an activator linked to the transmitter, wherein the activator transmits a command to initialize the new security parameter.

23. The apparatus as in claim 22, wherein the instruction is to commit the new security parameter.

24. The apparatus as in claim 22, further comprising a determintor linked to the transmitter.

25. The apparatus as in claim 24, wherein the determinator determines the computer network topology.

26. The apparatus as in claim 24, wherein the determinator determines a current security parameter.

27. A computer readable medium containing executable code comprising:
sending a new security parameter to an element in a computer network;
placing the new security parameter in an active database of the element; and
activating the new security parameter.

28. The computer readable medium as in claim 27, wherein the element is a switch.

29. The computer readable medium as in claim 28, further comprising transmitting the security parameter to a network endpoint element in response to the switch receiving the new security parameter.

30. The computer readable medium as in claim 27, wherein the new security parameter is stored in a pending database of the element.

31. The computer readable medium as in claim 29, wherein the new security parameter is stored in a pending database of the network endpoint element.

32. The computer readable medium as in claim 29, wherein the switch, in response to receiving an activate command, distributes the activate command to the network endpoint element.

33. The computer readable medium as in claim 27, wherein the step of activating the new security command comprises exchanging security capability parameters (ESCP) among elements in the computer network.

34. The computer readable medium as in claim 33, wherein if the ESCP is successful, then the elements exchange a network element list.

35. The computer readable medium as in claim 33, wherein if the ESCP is not successful, then a link is shut down.

36. The computer readable medium as in claim 34, wherein if the network element list is not successful, then a link will shut down.

37. The computer readable network as in claim 27, wherein the computer network is fiber channel network.
